(19) United States
(12) Patent Application Publication
(10) Pub. No.: US 2021/0047159 A1
(43) Pub. Date: Feb. 18, 2021

(54) VEHICLE LIFT WITH HIGH-CAPACITY ADJUSTABLE BRIDGE

(71) Applicant: Vehicle Service Group, LLC, Madison, IN (US)

(72) Inventors: Gerry Lauderbaugh, Madison, IN (US); Brad Gee, Madison, IN (US); Roger Ward, Madison, IN (US); Steven Taylor, Madison, IN (US)

(73) Assignee: Vehicle Service Group, LLC, Madison, IN (US)

(21) Appl. No.: 16/537,851

(22) Filed: Aug. 12, 2019

(51) Int. Cl. B66F 7/06; B66F 7/10; B66F 7/28; B66F 7/08

(52) U.S. Cl. CPC B66F 7/0658; B66F 7/08; B66F 7/28; B66F 7/10

(57) ABSTRACT

A vehicle lift includes a base, a platform assembly, and an actuation member. The platform assembly includes a platform base, an adjustable bridge slidably coupled with the platform base, and a friction-reduction assembly that biases the adjustable bridge away from the platform base. The friction-reduction assembly may include a retractable flat surface, a ball, or other component made of a friction-reducing material, such as a plastic material, that recesses into the platform by way of compression springs, wave spring washers, Belleville washers, a rebounding material, or the like. A pair of lifts may be tied together by a brace at one end or both for additional structural support.

### BACKGROUND

A vehicle lift is a device operable to lift a vehicle such as a car, truck, bus, etc. Some vehicle lifts operate by positioning two or more scissor lift assemblies underneath a vehicle, typically from between runway platforms or in a floor pit. The vehicle may then be driven or rolled into position above the two scissor lift assemblies while the scissor lift assemblies are in a retracted position. The scissor lift assemblies may be actuated to extend the height of the scissor lift assemblies, thus raising the vehicle to a desired height. Where two scissor lift assemblies are utilized, the scissor lift assemblies may be positioned at a central location relative to the vehicle's body such that the vehicle may balance on the scissor lift assemblies (e.g., under each axle). Once the user has completed his or her task requiring the vehicle lift, the vehicle may be lowered. In some instances, the scissor lift assemblies may be actuated by a hydraulic cylinder or other similar device.

While a variety of vehicle lifts have been made and used, it is believed that no one prior to the inventor(s) has made or used an invention as described herein.

### BRIEF DESCRIPTION OF THE DRAWINGS

While the specification may conclude with claims which particularly point out and distinctly claim the invention, it is believed the present invention will be better understood from the following description of certain examples taken in conjunction with the accompanying drawings, in which like reference numerals identify the same elements and in which:

FIG. 1 is a perspective view of an exemplary scissor lift assembly in an expanded configuration;

FIG. 2 is a cross-sectional perspective view of the scissor lift assembly of FIG. 1, taken along line 2-2 of FIG. 1;

FIG. 3A is a cross-sectional side view of the scissor lift assembly of FIG. 1 in a retracted configuration, taken along line 3-3 of FIG. 1;

FIG. 3B is a cross-sectional side view of the scissor lift assembly of FIG. 1 in the expanded configuration, taken along line 3-3 of FIG. 1;

FIG. 4 is an exploded perspective view of the scissor lift assembly of FIG. 1;

FIG. 5 is a perspective view of a platform assembly of the scissor lift assembly of FIG. 1;

FIG. 6 is an exploded perspective view of the platform assembly of FIG. 5;

FIG. 7 is a partial exploded view of a retractable friction reduction assembly of the platform assembly of FIG. 5;

FIG. 8A is a perspective view of the scissor lift assembly of FIG. 1 in retracted configuration, where the platform assembly of FIG. 5 is in a first configuration;

FIG. 8B is a perspective view of the scissor lift assembly of FIG. 1 in the retracted configuration, where the platform assembly of FIG. 5 is in a second configuration;

FIG. 9A is a cross-sectional view of the platform assembly of FIG. 5, where the scissor lift assembly of FIG. 1 is in the retracted position and disengaged from a load;

FIG. 9B is a cross-sectional view of the platform assembly of FIG. 5, where the scissor lift assembly of FIG. 1 is raised to initially engage the load of FIG. 9A;

FIG. 9C is a cross-sectional view of the platform assembly of FIG. 5, where the scissor lift assembly of FIG. 1 is raised to lift the load of FIG. 9A;

FIG. 10A is a perspective view of a vehicle lifting station incorporating the scissor lift assembly of FIG. 1, where a four-post lift assembly of the vehicle lifting station is in a lowered position, and where a pair of scissor lift assemblies is in a first longitudinal position and a lowered position;

FIG. 10B is a perspective view of the vehicle lifting station of FIG. 10A, where the four-post lift assembly of FIG. 10A is in the lowered position, and where the pair of scissor lift assemblies of FIG. 10A is in a second longitudinal position and the lowered position;

FIG. 10C is a perspective view of the vehicle lifting station of FIG. 10A, where the four-post lift assembly of FIG. 10A is in a raised position, and where the pair of scissor lift assemblies of FIG. 10A is in the second longitudinal position and the lowered position; and

FIG. 10D is a perspective view of the vehicle lifting station of FIG. 10A, where the four-post lift assembly of FIG. 10A is in the raised position, and where the pair of scissor lift assemblies of FIG. 10A is in the second longitudinal position and a raised position.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the resent invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is, by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

I. Overview of Exemplary Scissor Lift

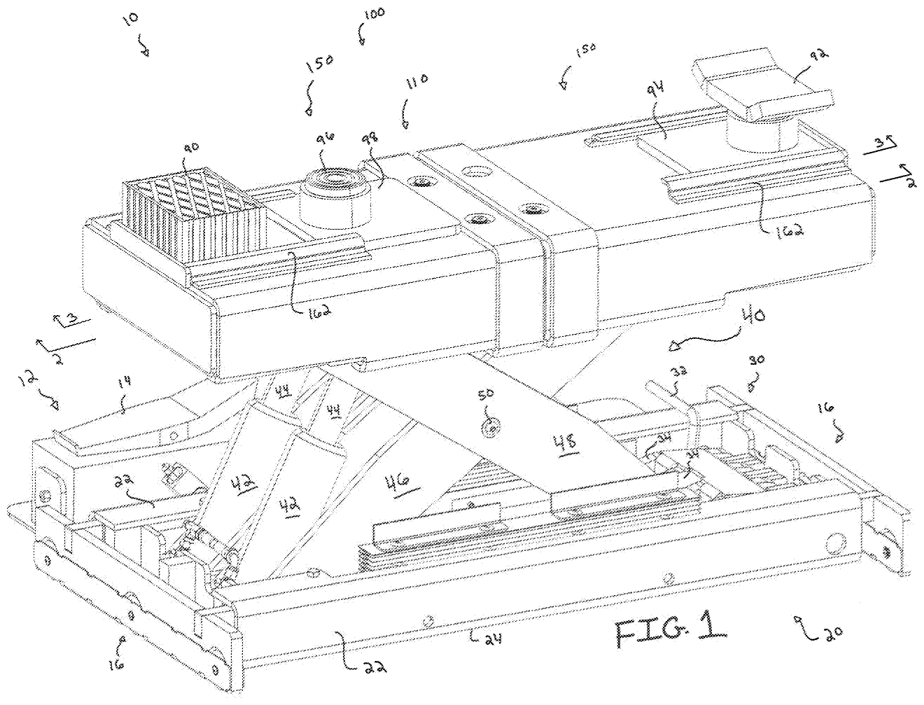

FIG. 1 shows a perspective view of an exemplary scissor lift assembly (10) in a raised position. A vehicle lift system in some embodiments comprises two scissor lift assemblies (10), a hydraulic pump assembly (not shown), and a synchronizer (not shown). Such a vehicle lift system, including one or more scissor lift assemblies (10), is operable to lift a vehicle to a desired height by actuating the scissor lift assemblies (10) from a retracted position to an extended position, such as that shown in FIG. 1. For example, scissor lift assemblies (10) may be positioned to correspond to each axle of a vehicle. Thus, scissor lift assemblies (10) support a vehicle by engaging each axle while raising the vehicle to a desired height. In various embodiments, scissor lift assemblies (10) are actuated by hydraulic actuators having hydraulic cylinders (42) and pistons (44) disposed therein, but in other embodiments different actuation structures will be used as will occur to those of ordinary skill in the art. Of course, it should be understood that any suitable number of scissor lift assemblies (10) may be used in a system. For instance, in some examples four scissor lift assemblies (10) may be used with one scissor lift assembly (10) being positioned at each corner of a vehicle. In other examples, one scissor lift assembly (10) may be used on each (left and right) side of the vehicle.

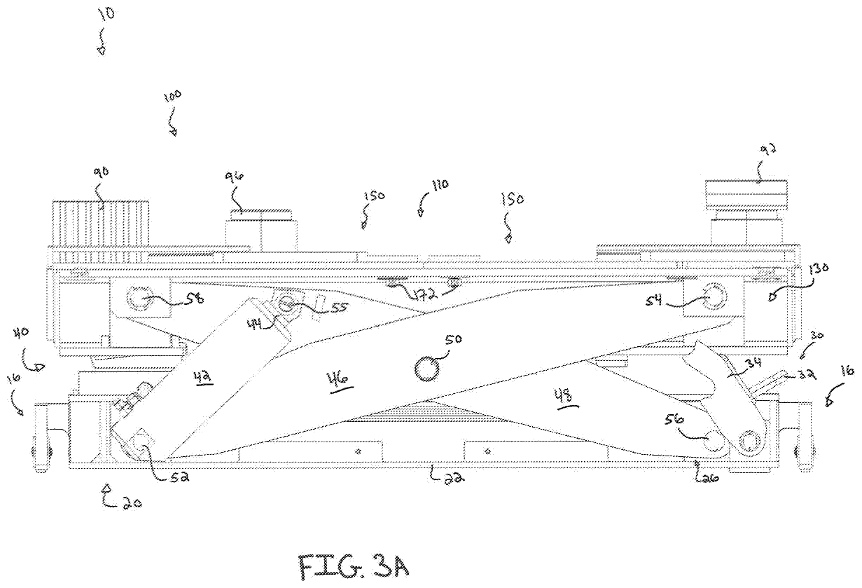

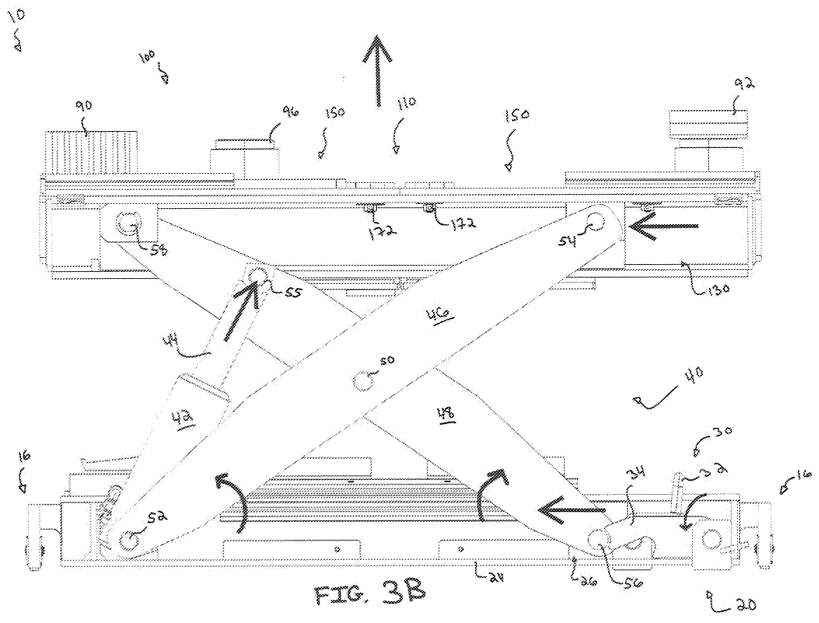

Scissor lift assembly (10) comprises a base assembly (20), an actuating assembly (40), and a platform assembly (100). As will be described in greater detail below, actuation assembly (40) is configured to actuate platform assembly (100) relative to base assembly (20) between a retracted position (as shown in FIG. 3A) and an expanded position (as shown in FIG. 3B) in order to lift a vehicle or any other suitable object as will be apparent to one having ordinary skill in the art in view of the teachings herein.

Base assembly (20) provides a stable platform to which actuation assembly (40), and therefore platform assembly (100), may mount. Base assembly (20) includes a bottom plate (24), a pair a side braces (22) on lateral ends of bottom plate (24), wheel assemblies (16) on longitudinal ends of bottom plate (24), an actuation control assembly (12), and a lock assembly (30). Side braces (22) extend upwardly from bottom plate (24) such that each side brace (22) and corresponding portions of bottom plate (24) define a slide channel (26). As will be described in greater detail below, slide channel (26) supports various elements of actuation assembly (40) to allow actuation assembly (40) to raise and lower platform assembly (100).

In the current example, wheel assembly (16) allows scissor lift assembly (10) to be freely movable upon a track of a runway platform or rail on a floor pit. However, in some examples, scissor lift assembly (10) may be fixed in position on a shop floor or mounted below a shop floor. Actuating assembly control (12) comprises a control handle (14) configured to selectively extend and retract pistons (44) relative to their respective hydraulic cylinder (42). As will be described in greater detail below, extension and retraction of pistons (44) may raise and lower platform assembly (100) relative to base assembly (20). Lock assembly (30) comprises a handlebar (32) and a locking body (34). As best seen between FIGS. 3A-3B, as platform assembly (100) is raised from the retracted position to the extended position, locking body (34) may rotate downwards to a substantially horizontal position. Locking body (34) may engage a second base pivot pin (56) to mechanically prevent actuating assembly (40) from accidentally returning to the retracted position. When the user desires to lower platform assembly (100), the user may actuate locking body (34) upward out of engagement with second base pivot pin (56) via handlebar (32), and then lower platform assembly in accordance with the description herein.

When scissor lift assembly (10) is in the retracted position, platform assembly (100) may be positioned relatively close to base assembly (20) and thus near the runway platform or shop floor driving surface. Such positioning of platform assembly (100) may permit a vehicle to be driven or rolled over scissor lift assembly (10) prior to initiation of the lifting process.

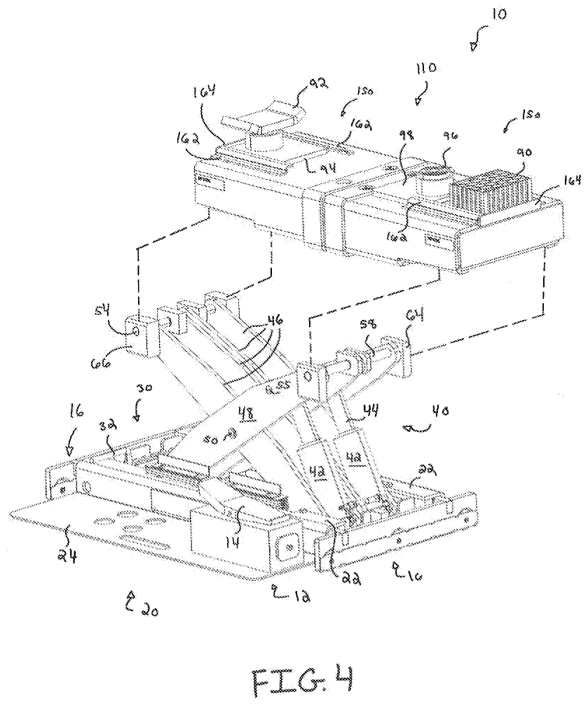

Platform assembly (100) is generally shaped as a longitudinally extending rectangle. Platform includes a base platform (110) and a pair of adjustable bridges (150) that are attached to base platform (110). As will be described in greater detail below, adjustable bridges (150) may be moved longitudinally along base platform (110) in order to change the longitudinal length of platform assembly (100) to accommodate various vehicles and/or other objects. As best seen in FIGS. 1-4, adjustable bridges (150) include a pair of adapter brackets (162). Adapter brackets (162) are dimensioned to receive various types of vehicle engagement adapters (90, 92, 96) such that vehicle engagement adapters (90, 92, 96) move with platform assembly (100) during exemplary use of scissor lift assembly (10). Vehicle engagement adapter (90) is a solid rubber lift block. Vehicle engagement adapter (92) is a frame cradle adapter. Finally, vehicle engagement adapter (96) is a lift pad adapter.

Base plates (94, 98) may be attached to vehicle engagement adapters (90, 92, 96). Base plates (94, 98) may slide within the confines of adapter brackets (162) to help secure vehicle engagement adapters (90, 92, 96) to platform assembly (100). Adapter brackets (162) may define a channel dimensioned to slidably receive base plates (94, 98) such that base plates (94, 98) may longitudinally slide along the length of adapter brackets (162) while adapter brackets (162) may substantially restrict lateral and vertical movement of base plates (94, 98) (and a corresponding adapter (90, 92, 96)) relative to adjustable bridges (150). Each bracket (162) includes an interior surface facing the opposite bracket (162). Interior surfaces of each bracket (162) help define channels. Therefore, channels defined by each bracket (162) face each other, such that brackets (162) together define an “inside track” for adapters (90, 92, 96) to slide along.

In some instances, vehicle engagement adapter (90, 92, 96) may not be attached to a base plate (94, 98) configured to fit within a channel defined by adapter brackets (162), such as a solid rubber block of vehicle engagement adapter (90). In such instances, solid rubber block may slide longitudinally along the length of adapter brackets (162), while adapter brackets (162) may restrict lateral movement of solid rubber block relative to adjustable bridges (150).

As mentioned above, adjustable bridges (150) may be moved longitudinally along base platform (110) in order to change the longitudinal length of platform assembly (100) to accommodate various vehicles and/or other objects. Therefore, a user may move adjustable bridges (150) relative to base platform (110) such that platform assembly (100) has a general length suitable to accommodate lifting a desired vehicle. Then, with adjustable bridges (150) in the desired position, a user may further adjust the position of adapters (90, 92, 96) relative to adjustable bridges (150) in order to precisely align adapters (90, 92, 96) with corresponding points on a vehicle to be lifted.

While the current example shows various kinds of vehicle engagement adapters (90, 92, 96) being used, any suitable combination of vehicle engagement adapters (90, 92, 96) may be used as will be apparent to one having ordinary skill in the art in view of the teachings herein.

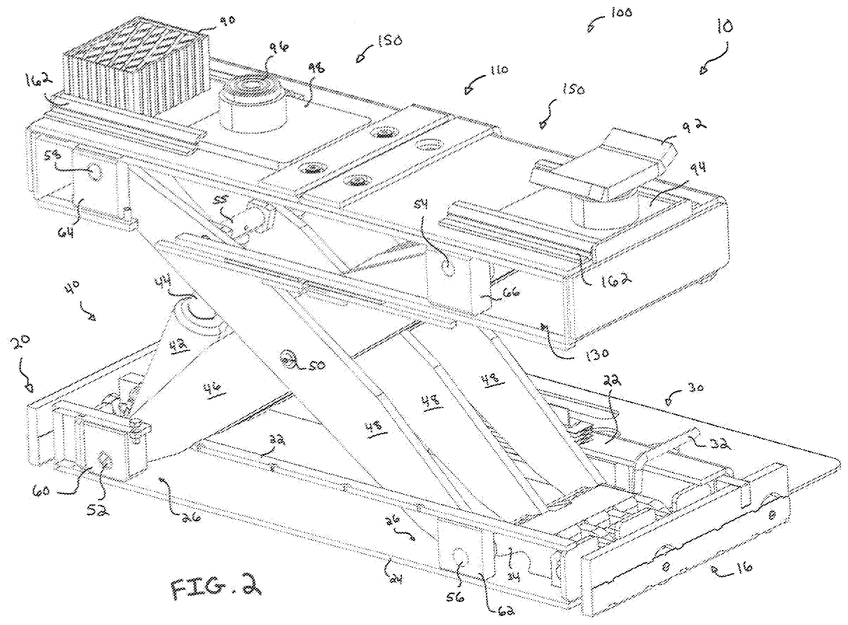

As best seen in FIGS. 2-3B, lateral edges of base platform (110) define a slide channel (130). Similar to slide channel (26) of base assembly (20), slide channel (130) of platform assembly (100) supports various elements of actuation assembly (40) to allow actuation assembly (40) to raise and lower platform assembly (100).

As mentioned above, and as will be described in greater detail below, actuation assembly (40) is configured to actuate platform assembly (100) relative to base assembly (20) between a retracted position (as shown in FIG. 3A) and an expanded position (as shown in FIG. 3B). Actuation assembly (40) includes hydraulic cylinders (42) having respective pistons (44), a set of first links (46), a set of second links (48), fixed base blocks (60), sliding base blocks (62), fixed platform blocks (64), and sliding platform blocks (66).

First links (46) extend between fixed base blocks (60) and sliding platform blocks (66). First links (46) are pivotably coupled at fixed base blocks (60) via first base pivot pin (52) and are pivotably coupled at sliding platform blocks (66) via first platform pivot pin (54). Fixed base blocks (60) are fixed within slide channels (26) of base assembly (20); while sliding platform blocks (66) are slidably contained within slide channel (130) of platform assembly (100). Therefore, as hydraulic cylinders (42) and pistons (44) lift platform assembly (100) in accordance with the description herein, first links (46) pivot about both pins (52, 54), while fixed base blocks (60) remain stationary and sliding platform blocks (66) translate.

Second links (48) extend between sliding base blocks (62) and fixed platform block (64). Second links (48) are pivotably coupled at sliding base blocks (62) via second base pivot pin (56) and are pivotably coupled at fixed platform block (64) via second platform pivot pin (58). Sliding base blocks (62) are slidably contained within slide channels (26) of base assembly (20); while fixed platform blocks (64) are fixed within slide channels (130) of platform assembly (100). Therefore, as hydraulic cylinders (42) and pistons (44) lift platform assembly (100) in accordance with the description herein, second links (48) pivot about both pins (56, 58), while fixed platform blocks (64) remain stationary and sliding base blocks (62) translate.

First links (46) and second links (48) are pivotably coupled to each other via linkage coupling pin (50), while second link (48) is further pivotably coupled with piston (44) via piston pivot coupling (55). Hydraulic cylinders (42) are pivotably coupled with base assembly (20) via first base pivot pin (52) as well. Therefore, as best seen between FIGS. 3A-3B, when the operator desires to raise platform assembly (100) from the retracted position toward the extended position, the operator may actuate pistons (44) away from their respective hydraulic cylinders (42). In the current example, the operator may utilize control handle (14) to actuate pistons (44) in accordance with the teachings herein, although this is merely optional.

Since pistons (44) are pivotably coupled to second links (48), actuation of pistons (44) away from cylinders (42) pivots second links (48) upward about pins (56, 58) in the clockwise direction in reference to the view shown in FIG. 3B, thereby raising second platform pivot pin (58) and fixed platform block (64), while hydraulic cylinders (42) and pistons (44) pivot in the counter-clockwise direction. Sliding base block (62) is driven toward fixed base blocks (60) within sliding channel (26), which causes locking body (34) to pivot into the locked configuration as shown in FIG. 3B. Since second links (48) are coupled with first links (46) via linkage coupling pin (50), pivoting second links (48) upwards in the clockwise direction also pivots first links (46) about pins (52, 54) in the counterclockwise direction in reference to the view shown in FIG. 3B, thereby raising first platform pivot pin (54) and sliding platform block (66). Sliding platform block (66) is driven toward fixed platform blocks (64) within sliding channel (130). As a result of platform blocks (64, 66) being raised, platform assembly (100) is also raised due to blocks (64, 66) being coupled with platform assembly (100) via channels (130).

When the operator desires to lower platform assembly (100), they may actuate piston (44) toward cylinder (42), such that first and second links (46, 48) pivot back toward base assembly (20) and platform assembly (100) is lowered.

II. Adjustable Bridges with Retractable Friction Reduction Assembly

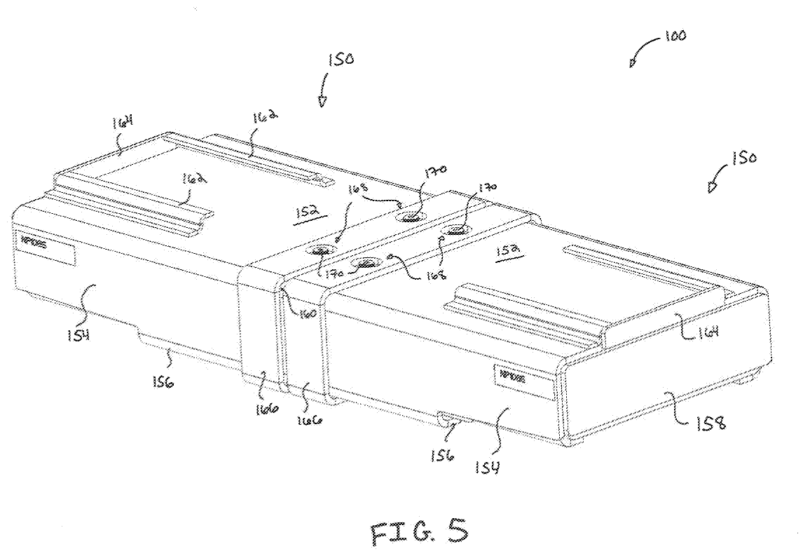

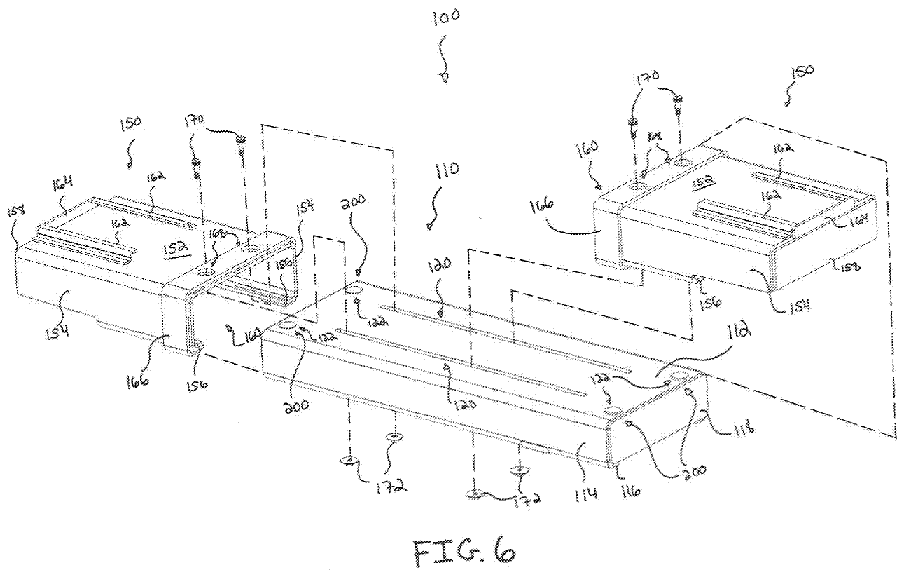

As mentioned above, adjustable bridges (150) may be moved longitudinally along base platform (110) in order to change the longitudinal length of platform assembly (100) to accommodate various vehicles and/or other objects with different dimensions. As shown in FIGS. 5-6, platform assembly (100) includes two adjustable bridges (150), each defining a coupling channel (160) dimensioned to slide over the top of base platform (110). Base platform (110) extends between two longitudinal ends (118). Base platform (110) further includes a top surface (112) extending laterally into two downwardly presented side surfaces (114), where each side surface (114) extends downward into a laterally presented lower surface (116).

A portion of top surface (112), side surface (114) and lower surface (116) define slide channels (130) that support blocks (64, 66) in accordance with the description herein. Additionally, top surface (112) defines a pair of longitudinally extending through slots (120). As will be described in greater detail below, through slots (120) are dimensioned to receive bolts (170) that are configured to suitably couple adjustable bridges (150) with base platform (110) in accordance with the description below.

Each adjustable bridge (150) includes adapter brackets (162) and adapter stop (164), which are configured to receive vehicle engagement adapters (90, 92, 96) in accordance with the description above.

Adjustable bridges (150) extend between an open end of coupling channel (160) and a longitudinal end (118). Adjustable bridges (150) further include a top surface (152) extending laterally into two downwardly presented side surfaces (154), where each side surface (154) extends downward into a laterally presented lower surface (156). Top surface (152), side surfaces (154), and lower surfaces (156) together define coupling channel (160). Open end of coupling channel (160) may be slid over longitudinal ends (118) of base platform (110) such that adjustable bridge (150) is supported by base platform (110). The geometric shape of coupling channel (160) is slightly larger than the exterior perimeter of base platform (110) such that coupling channel (160) may slide longitudinally along base platform (110).

Each adjustable bridge (150) further includes a reinforcement bracket (166) configured to provide structural support for adjustable bridges (150) as they distribute the load (L) of a vehicle/other object to the base platform (110) during use. Reinforcement brackets (166) and a portion of top surface (152) together define a pair of through holes (168). As best seen in FIG. 6, each through hole (168) is dimensioned to receive a threaded bolt (170), which may also extend through a corresponding longitudinal slot (120). The threaded portion of bolt (170) extending below top surface (152) and through longitudinal slot (120) may couple with a nut and washer (172) in order to suitably couple adjustable bridges (150) with base platform (110) in accordance with the description herein.

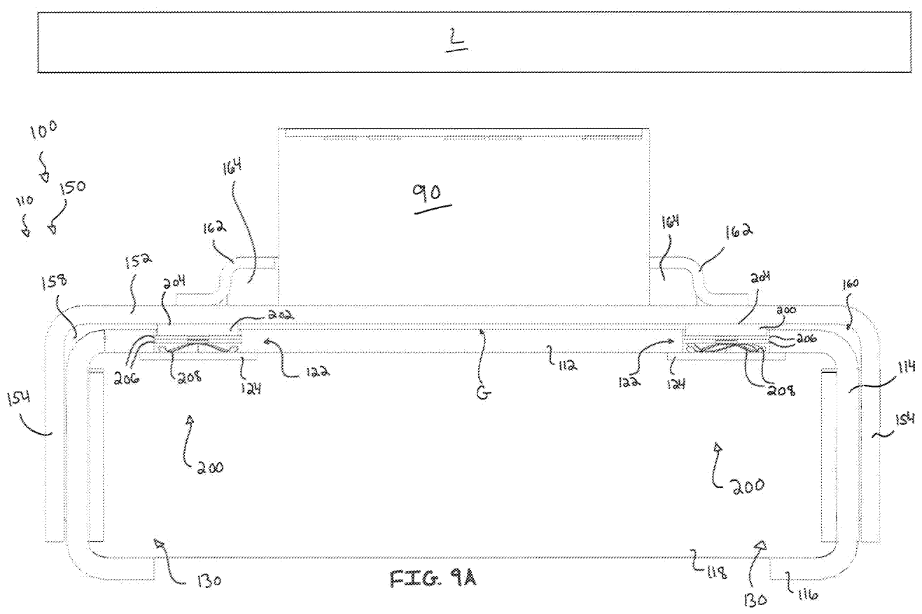

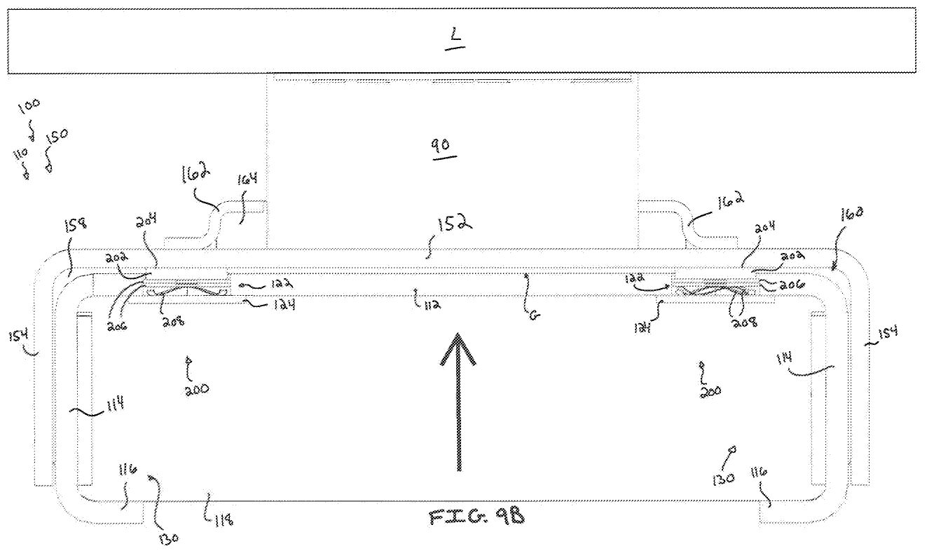

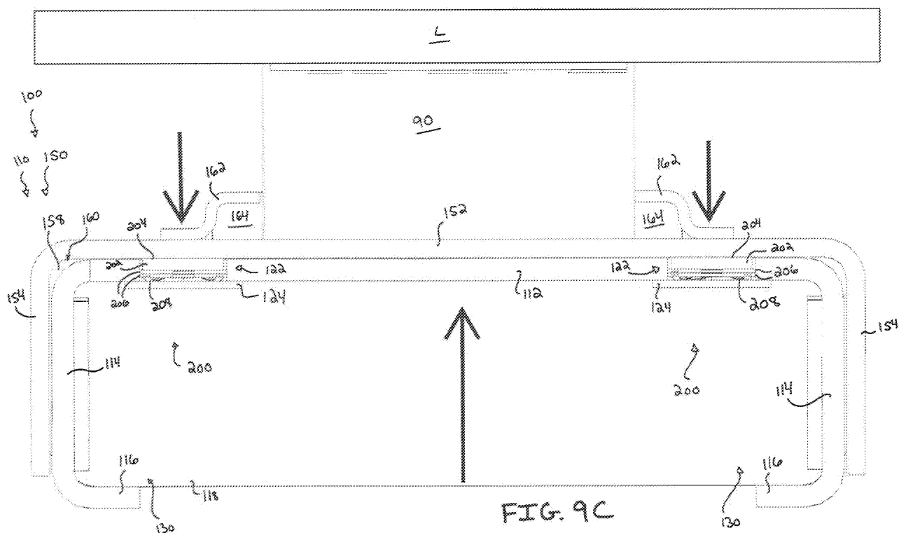

In particular, while bolt (170) is suitably engaged with nut and washer (172), a user may rotate bolt (170) in one rotational direction to urge nut and washer (172) toward the underside of top surface (112) while simultaneously urging the head of bolt (170) against the exterior of top surface (152), thereby providing a sufficient downward force on adjustable bridges (150) toward base platform (110). The downward force on adjustable bridges (150) may be adjusted such that retractable friction reduction assemblies (200) suitably engage adjustable bridges (150) to define vertical gap (G) (as shown in FIG. 9A) with base platform (110) in accordance with the description herein. In some instances, the weight of adjustable bridges (150) may provide enough downward force for retractable friction reduction assemblies (200) to suitably define vertical gap (G) between adjustable bridges (150) and base platform (110) in accordance with the description herein. In such instances, bolt (170) may suitably engage a respective nut and washer (172) to provide a nominal downward force.

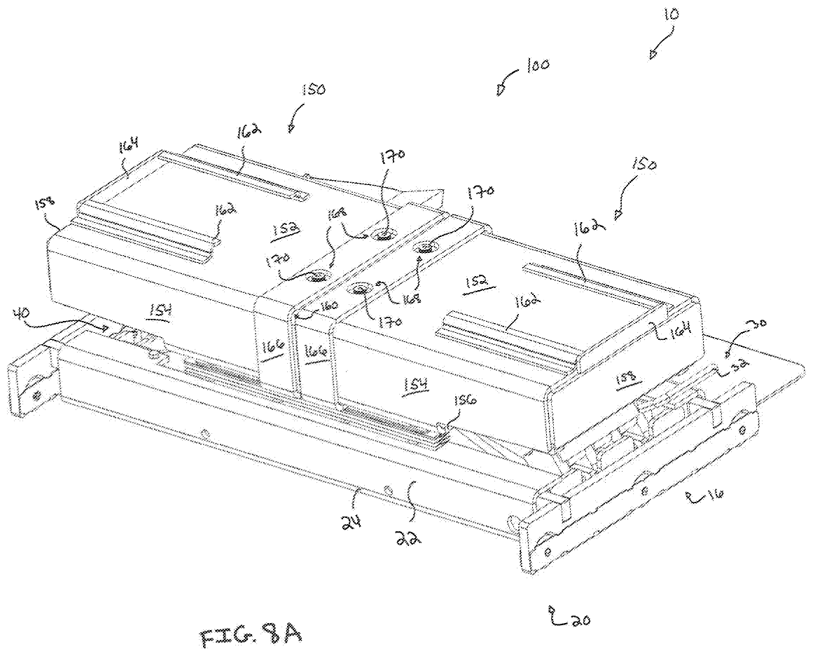

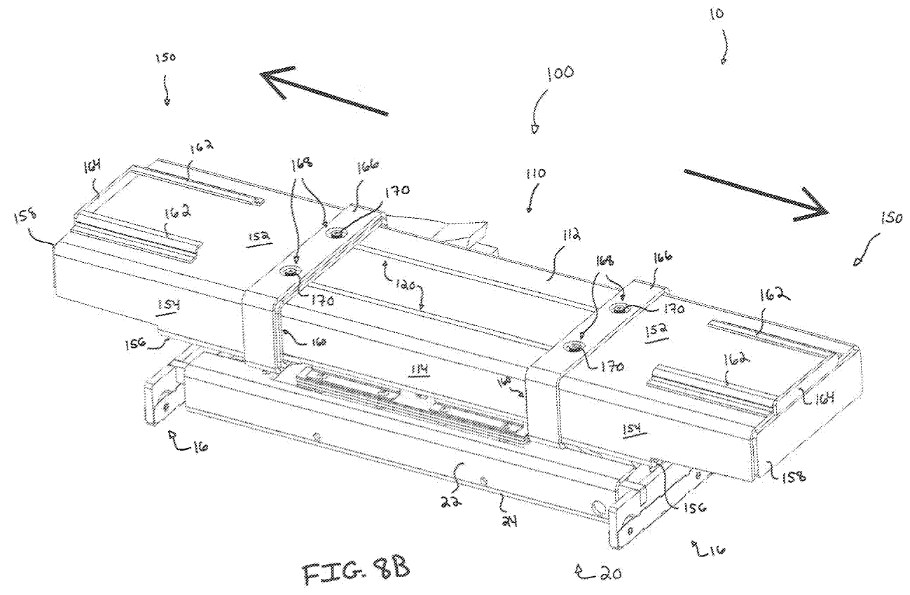

As exemplified between FIGS. 8A-8B, with adjustable bridges (150) suitably coupled with base platform (110), a user may provide a sufficient translating force on adjustable bridge (150) in order to longitudinally slide adjustable bridge (150) to a desired location relative to base platform (110). As will be described in greater detail below, retractable friction reduction assemblies (200) creating vertical gap (G) may reduce the amount of force required to longitudinally move adjustable bridges (150) relative to base platform (110).

Bolts (170) also act as stop bolts to keep adjustable bridge (150) from traveling longitudinally beyond the intended longitudinal movement by striking the outer region of the longitudinal slots (120) in the base platform (110). Therefore, bolts (170) longitudinally restrict the range of motion of adjustable bridge (150) relative to base platform (110) along the path defined by longitudinally extending slot (120). In other words, bolts (170) may interact with both through holes (168) of adjustable bridges (150) and longitudinal slots (120) of base platform (110) in order to prevent adjustable bridges (150) from sliding out of engagement with base platform (110).

Adjustable bridges (150) may need to be made of a sufficient amount of material to maintain structural integrity while lifting a vehicle or other heavy load. In other words, adjustable bridges (150) may require a specific thickness such that when adjustable bridges (150) are under load, they do not structurally deform, break, or otherwise fail. However, the more material that is used to form adjustable bridges (150), the more adjustable bridges (150) will weigh. If too much material is used to form adjustable bridges (150), it may become too difficult to move adjustable bridges (150) relative to base platform (110) in accordance with the description herein. In other words, if adjustable bridges (150) are made with too much material in order to accommodate a heavier load (L), bridges (150) may no longer be readily adjustable due to the increased frictional resistance between adjustable bridges (150) and base platform (110). Currently, adjustable bridges (150) may be limited in their load carrying capacity based on the corresponding difficulty of translating bridges (150) relative to base platform (110).

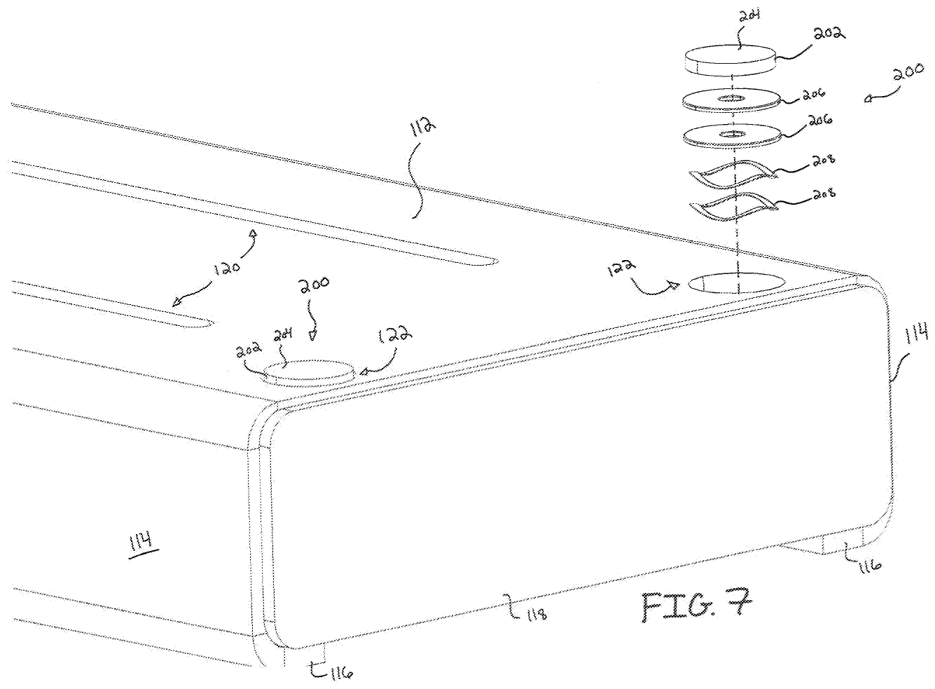

Therefore, it may be desirable to have an assembly that reduces the amount of translating force required to move adjustable bridges (150) relative to base platform (110). Further, it may be desirable to reduce the amount the frictional resistance between adjustable bridges (150) and base platform (110) in order to reduce the amount of translating force required to move adjustable bridges (150). Reducing the amount of translating force required to move adjustable bridges (150) may allow adjustable bridges (150) to be made of more material, thereby increasing the load (L) bridges (150) can carry. FIG. 7 shows a retractable friction reduction assembly (200). As will be described in greater detail below, retractable friction reduction assemblies (200) are configured to reduce the amount of force required to slide adjustable bridges (150) into a desired longitudinal location relative to base platform (110).

Top surface (112) of base platform (110) defines four recessed pockets (122), which terminate at pocket floors (124) (as best seen in FIGS. 9A-9C). Recessed pockets (122) and pocket floors (124) house retractable friction reduction assembly (200). In the current example, there are four recessed pockets (122), four pocket floors (124), and four retractable friction reduction assemblies (200). Retractable friction reduction assembly (200) are configured to transition between an outward configuration (as shown in FIG. 9A) and an inward configuration (as shown in FIG. 9C).

In the outward configuration, retractable friction reduction assembly (200) is configured to a support at least a portion of adjustable bridges (150) to reduce the frictional resistance between adjustable bridges (150) and base platform (110). In the inward configuration, retractable friction reduction assembly (200) may sufficiently retract into recessed pockets (122) such that top surface (112) of base platform (112) sufficiently engages the underside of top surface (152) of bridge (150). As will be described in greater detail below, retractable friction reduction assembly (200) may transition between the outward configuration and the inward configuration based on the amount of downward force imparted on adjustable bridges (150).

Retractable friction reduction assemblies (200) include a reduced-friction body (202), a plurality of spacers (206), such as washers, and a plurality of biasing members (208), such as wave spring washers. Biasing members (208) are located closest to pocket floors (124), while spacers (206) are disposed between biasing members (208) and reduced-friction body (202). Reduced-friction body (202) includes a bridge engagement surface (204). Reduced-friction body (202) may be made of a material having a lower coefficient of friction than the material forming the top surface (112) of base platform (110). For example, reduced-friction body (202) may be formed from a plastic material.

Biasing members (208) have a sufficient spring constant/resiliency to bias bridge-engagement surface (204) above top surface (112) (i.e., toward the outward configuration). In particular, biasing members (208) are configured to bias bridge-engagement surface (204) above top surface (112) such that bridge-engagement surface (204) supports top surface (152) of adjustable bridge (150) when adjustable bridge (150) is not under the influence of a sufficient external downward force by load (L) from a vehicle or other object. When bridge-engagement surface (204) supports top surface (152) of adjustable bridge (150) in the outward configuration, top surfaces (112, 152) together define a gap (G). Due to the presence of gap (G), the frictional resistance between top surfaces (112, 152) may be reduced or eliminated.

Additionally, since reduced-friction body (202) may comprise a material having a lower coefficient of friction as compared to top plate (112), the frictional resistance between bridge-engagement surfaces (204) and top surface (152) of bridge (150) may be less than the frictional resistance if top surfaces (112, 152) were to directly engage each other without gap (G). The reduced frictional resistance may allow the user to more easily longitudinally translate adjustable bridges (150) relative to base platform (110) in accordance with the description above. Reducing the frictional resistance between adjustable bridges (150) and base platform (110) may allow adjustable bridges (150) to include more material while retaining the adjustable nature of bridges (150), which in turn may allow platform assembly (100) to accommodate heavier loads. In the outward configuration, at least a portion of reduced-friction body (202) is within the confines of recessed pockets (122) such that sliding of adjustable bridge (150) does not actuate reduced-friction body (202) out of recessed pockets (122).

Biasing members (208) also have a sufficient spring constant to compress biasing members (208) when adjustable bridge (150) experiences a sufficient downward force such that reduced-friction body (202) retracts into recessed pockets (122) (i.e., the inward configuration), thereby allowing top surfaces (112, 152) to engage each other, sufficiently eliminating the presence of gap (G) and increasing the frictional resistance between top surfaces (112, 152). With top surfaces (112, 152) engaged and reduced-friction body (202) retracted into recessed pockets (122), scissor lift assembly (10) may suitably lift a vehicle or any other load. Any sufficient downward force may be applied to suitably compress the biasing members (208), as would be apparent to one having ordinary skill in the art in view of the teachings herein.

In some instances, as shown between FIGS. 9A-9C, when scissor lift assembly (10) sufficiently engages and lifts a load (L), such as a vehicle, load (L) may provide the downward force needed to compress biasing members (208). FIG. 9A shows platform assembly (100) located beneath a load (L) such that vehicle engagement adapter (90) is aligned with load (L). As shown in FIG. 9B, platform assembly (100) may be lifted in accordance with the description herein until engagement adapter (90) initially engages load (L), but load (L) does not present a sufficient downward force on bridge (150) to suitably compress biasing member (208). As shown in FIG. 9C, platform assembly (100) may be further lifted such that load (L) compresses biasing members (208) in accordance with the description herein, eliminating gap (G). Platform assembly (100) may then be further lifted to lift load (L).

In the current example, two spacers (206) and two biasing members (208) are used. In various alternative embodiments, any suitable number and type of spacers (206) may be used to sufficiently place reduced-friction body (202) in the proper positions when in the outward configuration and the inward configuration. Additionally, any suitable number and type of biasing members (208) may be utilized as would be needed to suitably transition reduced friction body (202) between the outward configuration and the inward configuration in response to a desired downward force. Any suitable number and type of spacers (206) and biasing members (208) may be used as would be apparent to one having ordinary skill in the art in view of the teachings herein. As mere examples, one spacer (206) and one biasing member (208) may be used; or three spacers (206) and two biasing members (208) may be used; or one spacer (206) and 4 biasing members (208) may be used.

In the current example, biasing members (208) include wave spring washers. However, any suitable biasing members (208) may be used as would be apparent to one having ordinary skill in the art in view of the teachings herein. For example, biasing members (208) may include compression springs, Belleville washers, and/or elements made of a rebounding material (such as EPDM rubber or other rubber or plastic).

In the current example, base platform (110) defines pocket recesses (122) to house retractable friction-reduction assembly (200). A suitable portion of adjustable bridge (150) may define pocket recesses (122) to house retractable friction-reduction assembly (200), which may also be used to reduce the frictional resistance between vehicle engagement adapters (90, 92, 96) and top plate (152) of bridge (150).

In the current example, reduced-friction body (202) is formed into a substantially flat arm-engagement surface (204), although this is optional as any suitable geometry may be used as would be apparent to one having ordinary skill in the art in view of the teachings herein. For example, a ball or wheel may be used for reduced-friction body (202).

III. Exemplary Vehicle Lifting Station Incorporating Exemplary Scissor Lift

As described above, scissor lift assembly (10) includes retractable friction reduction assemblies (200) that allow adjustable bridges (150) to be made of more material to increase the load (L) bridges (150) can carry while maintaining the adjustable nature of bridges (150) in accordance with the description herein. In some instances, a vehicle being lifted may be substantially heavier in a first localized region of the vehicle compared to a second localized region of the vehicle. For instance, some vehicles are substantially heavier on the rear end as compared to the front end. Some examples of vehicles that are substantially heavier in the rear end compared to the front end include ambulances and class six trucks, which may weigh up to 13,500 pounds in the rear end, that only around 7,500 pounds in the front end.

Therefore, some vehicle lifting stations may include a first scissor lift assembly (10) with a first lifting capacity to accommodate the heavier portion of the vehicle, and a second scissor lift assembly that does not necessarily require the same lifting capacity in order to accommodate the lighter portion of the vehicle. Some vehicle lifting stations may include a first scissor lift assembly (10) with retractable friction reduction assemblies (200) and a second scissor lift assembly without retractable friction reduction assemblies (200), such that the first scissor lift assembly (10) may include sufficient material to support the heavier load (L) and maintain the adjustable nature of bridges (150) in accordance with the description herein. The lighter lifting capacity of the second scissor lift assembly may allow the adjustable bridges of the second scissor lift assembly to be made from less material than first scissor lift assembly (10). Therefore, in some instances, the adjustable bridges of the second scissor lift assembly may maintain their adjustable nature without necessarily requiring the use of retractable friction reduction assemblies (200).

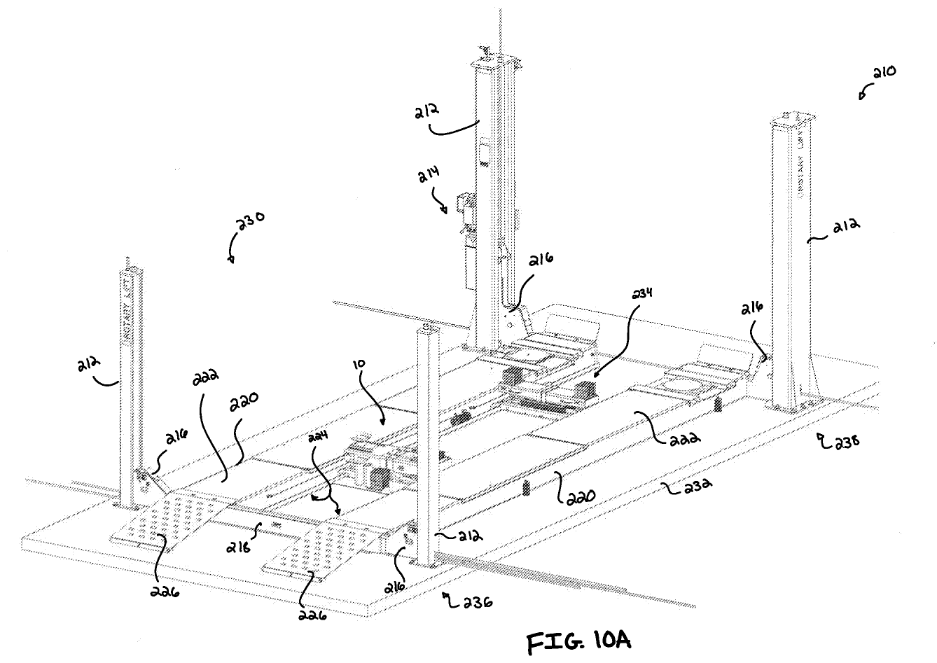

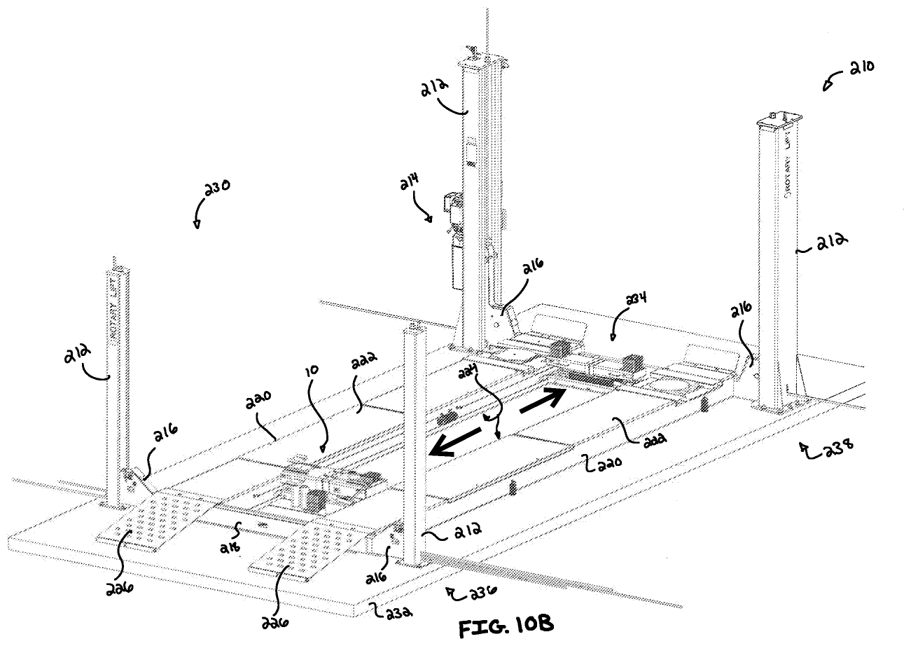

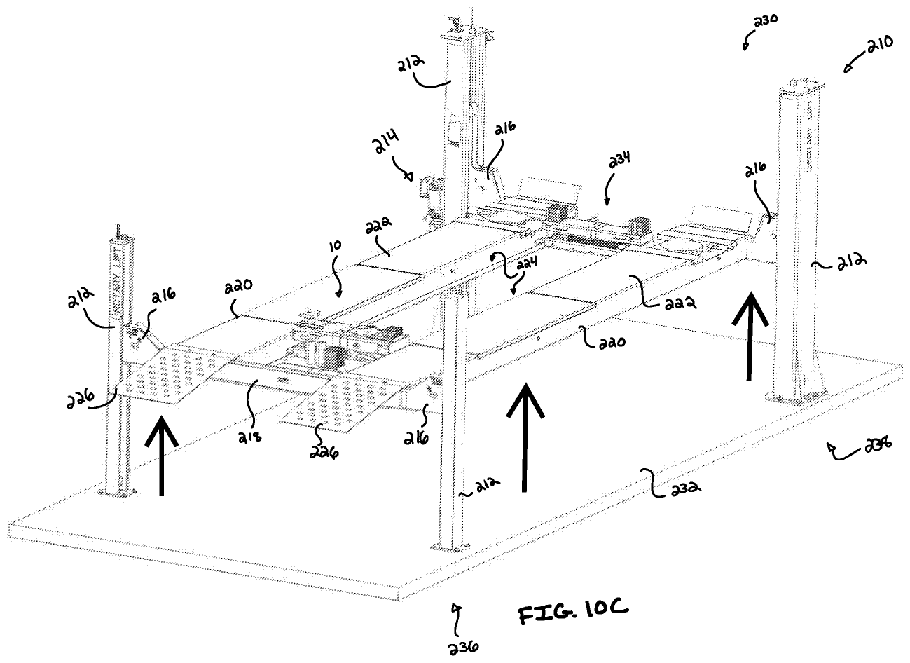

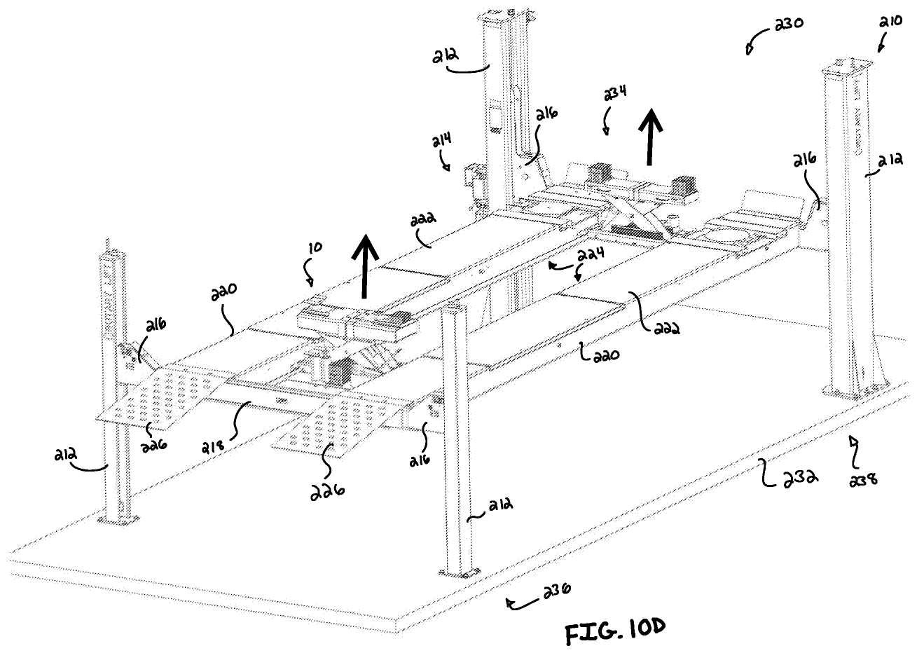

FIGS. 10A-10D show an exemplary vehicle lifting station (230). Vehicle lifting station (230) extends between a rear section (236) and a front section (238). Vehicle lifting station (230) includes rear scissor lift assembly (10), a front scissor lift assembly (234), and a four-post lift assembly (210). Front scissor lift assembly (234) may be substantially similar to rear scissor lift assembly (10) described above, with differences elaborated below. Front scissor lift assembly (234) may have sliding bridges made with less material compared to rear scissor lift assembly (10), and front scissor lift assembly (234) may not necessarily require retractable friction reduction assembly (200) described above. Therefore, front scissor lift assembly (234) and rear scissor lift assembly (10) may be configured to lift vehicles with a substantially heavier rear end compared to the front end. However, in some instances, front scissor lift assembly (234) may be exactly the same as rear scissor lift assembly (10); that is, the differences between scissor lift assemblies (10, 234) are merely optional.

As will be described in greater detail below, four-post lift assembly (210) is configured to raise a vehicle relative to the ground (232) to a first raised position by engaging the tires of the vehicle via a pair of runway platforms (220), thus allowing an operator to inspect and work on an underside of vehicle. As will also be described in greater detail below, first and second scissor lift assemblies (10, 234) are configured to raise the vehicle relative to runway platforms (220) to a second raised position by engaging other suitable locations on the vehicle, thereby lifting the tires of vehicle off runway platforms (220) and allowing an operator to remove tires from the vehicle while the vehicle is suitably raised relative the ground (232). Therefore, first and second scissor lift assemblies (10, 234) serve as a “jack lift.”

Four-post lift assembly (210) includes four posts (212), a respective actuating arm (216) for each post (212), a control assembly (214) associated with one or more posts (212), and a pair of runway platforms (220) extending between rear section (236) and front section (238). Each post (212) is fixed to and extends vertically from concrete ground (232). Two posts (212) are located at rear section (236) of vehicle lifting station (230), while two other posts (212) are located at front section (238) of vehicle lifting station (230). Each post (212) includes an actuating arm (216) configured to actuate vertically along a respective post (212). Actuating arms (216) may actuate vertically along posts (212) in synchronization. Actuating arms (216) may include a yoke and/or any other suitable structure(s) in order to actuate vertically along respective posts (212) as would be apparent to one skilled in the art in view of the teachings herein.

While four posts (212) are used in the current example, any suitable number of posts (212) and respective actuating arms (216) may be used as would be apparent on one skilled in the art in view of the teachings herein. While posts (212) and actuating arms (216) are used in the current vehicle lift station (230), this is merely optional. Any other suitable lifting mechanisms may be used as would be apparent to one skilled in the art in view of the teachings herein.

Each runway platform (220) is coupled to a respective actuating arm (216) at rear section (236) and front section (238) such that runway platforms (220) extend substantially parallel to each other. Runway platforms (220) are supported by cross-bracing frame (218) at rear section (236) of vehicle lifting station (230). As mentioned above, vehicle lifting station (230) may be configured to lift vehicles having a substantially heavier rear end compared to the front end. In such instances, cross-bracing frame (218) may extend between runway platforms (220) at rear section (236) in order to accommodate the heavier rear end of a lifted vehicle by promoting lateral stability of rear section (236). Since vehicle lifting station (230) may be required to lift a heavier rear portion of a vehicle compared to that supported by front section (238), front section (238) may not necessarily require a cross-bracing frame (218). The lack of a cross-bracing frame at front section (238) of vehicle lifting station (230) may provide for easier access between runway platforms (220) at front section (238), thereby providing easier access to the underside of a lifted vehicle. In other words, the space between runway platforms (220) at the end of front section (238) is “open” such that the operator may walk between runway platforms (220) without having to avoid a cross-bracing frame (218). In some instances, vehicle lifting station (230) may include a cross-bracing frame (218) at front section (238) (but not rear section (236)), while in other instances vehicle lifting station (230) may include a cross-bracing frame (218) at both front section (238) and rear section (236).

Runway platforms (220) may actuate relative to posts (212) along with actuating arms (216). In other words, actuating arms (216) are configured to vertically actuate runway platforms (220) relative to posts (212). Since actuating arms (216) actuate vertically along posts (212) in synchronization, ends of runway platforms (220) raise and lower relative to posts (212) in synchronization.

Each runway platform (220) includes a top surface (222) and a ramp (226) located at a rear end. Ramps (226) are dimensioned to allow a user to drive a vehicle on runway platform (220) such that tires of the vehicle are supported by top surface (222). Therefore, when four-post lift assembly (210) is in the lowered position as shown in FIG. 10A, an operator may drive the vehicle on top of runway platform (220) via ramps (226) such that a front end of vehicle is located at front section (238) while a rear end of vehicle is located at rear end (236).

Each runway platform (220) also defines a track (224). As mentioned above, and as shown in FIGS. 10A-10B, rear scissor lift assembly (10) and front scissor lift assembly (234) are slidably attached to tracks (224) via wheel assemblies (16). Therefore, after a vehicle has been driving on top surfaces (222) of runway platforms (220), an operator may selectively position scissor lift assemblies (10, 234) along the length of platform runways (220) in order to suitably align appropriate elements of scissor lift assemblies (10, 234) with an axle or other suitable component of a vehicle.

Additionally, adjustable bridges (150) may be adjusted in accordance with the description herein in order to suitably align scissor lift assemblies (10, 234) with desired portions of the vehicle. It should be understood that since rear scissor lift assembly (10) includes retractable friction reduction assemblies (200) allowing adjustable bridges (150) to include more material, adjustable bridges (150) of rear scissor lift assembly (10) may be configured to lift a heavier load (L) compared to front scissor lift assembly (234) while also maintaining the adjustable nature of bridges (150) described above. Therefore, scissor lift assemblies (10, 234) may be configured to lift vehicles with substantially heavier rear ends compared to front ends.

In some instances, the position of rear scissor lift assembly (10) and front scissor lift assembly (234) may be reversed, such that scissor lift assembly (10, 234) may lift vehicles with a substantially heavier front end compared to the rear end. In other instances, the vehicle may be backed onto assembly (210) so that rear scissor lift assembly (10) lifts the front of the vehicle while front scissor lift assembly (234) lifts the rear of the vehicle.

While only two scissor lift assemblies (10, 234) are used in the current example, any other suitable number of scissor lift assemblies (10, 234) may be used and arranged relative to each other as would be apparent to one skilled in the art in view of the teachings herein. While scissor lift assemblies (10, 234) are shown being positioned along platform runways (220) in the lowered position, scissor lift assemblies (10, 234) may be longitudinally positioned while platform runways (220) are in the raised position as well.

As shown between FIGS. 10B-10C, an operator may lift platform (220) from the lowered position to the raised position, thereby providing access to the underside of vehicle. Next, as shown between FIGS. 10C-10D, the operator may raise scissor lift assemblies (10, 234) from the lowered position to the raised position in order to lift wheels of the vehicle above top surface (222) in order to remove wheels from the rest of vehicle or any other suitable action as would be apparent to one skilled in the art in view of the teachings herein. As mentioned above, adjustable bridges (150) of rear scissor lift assembly (10) may be configured to lift a heavier load (L) compared to front scissor lift assembly (234), therefore allowing scissor lift assemblies (10, 234) to lift class six vehicles, ambulances, etc. while also along scissor lift assemblies (10, 234) to suitably align with desired portions of vehicle in order to raise tires of vehicle from top surface (222) of platforms (220).

Once the desired actions are completed, the operator may lower the vehicle back onto runway platforms (220). Next, the operator may lower runway platforms (220) back toward ground (232) and drive the vehicle off of vehicle lift station (230).

Control assembly (214) is configured to instruct actuating arms (216) to raise and lower along respective posts (212) simultaneously. Control assembly (214) may also be configured to instruct scissor lift assemblies (10, 234) to raise and lower as well. Therefore, an operator may control the lifting operations of vehicle lift assembly (230) via control assembly (214). Control assembly (214) may include any suitable structures and features as would be apparent to one skilled in the art in view of the teachings herein, such as a processor, memory, storage, user inputs, etc.

While not explicitly described herein, vehicle lifting station (230) may include any other suitable components as would occur to one skilled in the art in view of the teachings herein, in order to perform any suitable function that would be desirable to one skilled in the art in view of the teachings herein. For example, vehicle lifting station (230) may include one or more compressed air stations configured to generate and deliver compressed air to a targeted region. Vehicle lifting station (230) may include any suitable components for aligning tires and/or the frame of the vehicle while the vehicle is raised from ground (232) in accordance with the description herein.

It should be understood that any one or more of the teachings, expressions, embodiments, examples, etc. described herein may be combined with any one or more of the other teachings, expressions, embodiments, examples, etc. that are described herein. The teachings, expressions, embodiments, examples, etc. herein should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. A vehicle lift assembly comprising:
(a) a base member;
(b) an actuation assembly; and
(c) a platform assembly coupled with the actuation assembly, wherein the actuation assembly is configured to move the platform assembly vertically relative to the base member, wherein the platform assembly is configured to contact a vehicle in order to lift the vehicle relative to the base member, wherein the platform assembly comprises:
(i) a platform base,
(ii) an adjustable bridge slidably coupled with the platform base, and
(iii) a friction reduction assembly configured to selectively reduce a frictional resistance between the platform base and the adjustable bridge.

2. The vehicle lift assembly of claim 1, wherein the friction reduction assembly comprises a biasing member and a reduced-friction body.

3. The vehicle lift assembly of claim 2, wherein the platform base defines a recessed pocket, wherein the biasing member is at least partially housed within the recessed pocket.

4. The vehicle lift assembly of claim 3, wherein the platform base comprises a pocket floor, wherein the biasing member abuts against the pocket floor.

5. The vehicle lift assembly of claim 2, wherein the biasing member comprises a wave spring washer.

6. The vehicle lift assembly of claim 2, wherein the reduced-friction body comprises a plastic material.

7. The vehicle lift assembly of claim 6, wherein the reduced-friction body comprises a flat engagement surface.

8. The vehicle lift assembly of claim 1, wherein
the platform base comprises a first surface,
the adjustable bridge comprises a second surface facing the first surface, and
the friction reduction assembly is configured to bias the first surface away from the second surface.

9. The vehicle lift assembly of claim 1, wherein the platform base defines a longitudinal through slot.

10. The vehicle lift assembly of claim 1, wherein the adjustable bridge defines a coupling channel configured to slide over at least a portion of the platform base.

11. The vehicle lift assembly of claim 1, wherein the friction-reduction assembly is configured to transition between an outward configuration and an inward configuration, wherein the friction-reduction assembly is configured to define a gap between the platform base and the adjustable bridge in the outward configuration.

12. The vehicle lift assembly of claim 1, further comprising a second base member, a second actuation assembly and a second platform assembly, wherein the second actuation assembly is coupled to the second base member and the second platform assembly, wherein the second base member is moveable relative to the base member.

13. The vehicle lift assembly of claim 12, further comprising a first runway and a second runway configured to actuate between a lowered position and raised position, wherein the second base member and the base member are each slidably attached to both the first runway and the second runway.

14. A vehicle lift assembly comprising:
(a) a base member;
(b) an actuation assembly; and
(c) a platform assembly coupled with the actuation assembly, wherein the actuation assembly is configured to move the platform assembly vertically relative to the base member, wherein the platform assembly is configured to contact a vehicle in order to lift the vehicle relative to the base member, and wherein the platform assembly comprises:
(i) a platform base,
(ii) an adjustable bridge slidably coupled with the platform base, and
(iii) a retractable friction-reduction assembly configured to transition between an outward configuration and an inward configuration, wherein the retractable friction reduction assembly is configured to reduce a frictional resistance between the platform base and the adjustable bridge in the outward configuration, and wherein the platform base and the adjustable bridge are configured to contact each other when the retractable friction-reduction assembly is in the inward configuration.

15. The vehicle lift assembly of claim 14, wherein the retractable friction-reduction assembly comprises a biasing member.

16. The vehicle lift assembly of claim 15, wherein the biasing member comprises a wave spring.

17. The vehicle lift assembly of claim 14, wherein the retractable friction-reduction assembly is at least partially housed within the platform base.

18. A vehicle lift assembly comprising:
(a) a base member;
(b) an actuation assembly; and
(c) a platform assembly coupled with the actuation assembly, wherein the actuation assembly is configured to move the platform assembly vertically relative to the base member, wherein the platform assembly is configured to contact a vehicle in order to lift the vehicle relative to the base member, and wherein the platform assembly comprises:
(i) a platform base,
(ii) an adjustable bridge slidably coupled with the platform base, and
(iii) an adapter track attached to the adjustable bridge such that the adapter track is configured to slide relative to the platform base along with the adjustable bridge, wherein the adapter track is configured to receive a vehicle adapter.

19. The vehicle lift assembly of claim 18, wherein the adapter track comprises a first adapter bracket and a second adapter bracket, and wherein the vehicle adapter is at least partially held in place by the first adapter bracket and the second adapter bracket.

20. The vehicle lift assembly of claim 19, wherein the first adapter bracket comprises a first interior surface, wherein the second adapter bracket comprises a second interior surface, wherein the first interior surface and the second interior surface face each other to define an inside track configured to receive a portion of the vehicle adapter.

21. A vehicle lift assembly comprising:
(a) a runway assembly, wherein the runway assembly comprises:
(i) first runway,
(ii) a second runway extending substantially parallel to the first runway, wherein the first runway and the second runway extend from a first end toward a second end;
(b) a runway actuation assembly, wherein the runway actuation assembly is configured to raise and lower the runway assembly between a lowered position and a raised position;
(c) a first jack lift assembly slidably coupled to the first runway and the second runway along a path, wherein the first jack lift assembly is configured to raise a first maximum load; and
(d) a second jack lift assembly slidably coupled to the first runway and the second runway along the path, wherein the second jack lift assembly is located closer to the second end of the runway assembly compared to the first jack lift, wherein the second jack lift assembly is configured to raise a second maximum load, and wherein the second maximum load is smaller than the first maximum load.

22. The vehicle lift assembly of claim 21, wherein the runway assembly further comprises a cross-bracing frame extending between the first runway and the second runway located near the first end, wherein the first runway and the second runway located near the second end define an open space without a cross-bracing frame extending between the first runway and the second runway.
